(19) United States
(12) Patent Application Publication
(10) Pub. No.: US 2025/0180785 A1
(43) Pub. Date: Jun. 5, 2025

(54) METHODS OF FORMING AN ANTIREFLECTIVE LAYER ON A COMPLEX SUBSTRATE AND COMPLEX SUBSTRATES HAVING THE ANTIREFLECTIVE LAYER

(71) Applicant: University of Florida Research Foundation, Inc., Gainesville, FL (US)

(72) Inventors: Sin-Yen Leo, Gainesville, FL (US); Peng Jiang, Gainesville, FL (US); Zhuxiao Gu, Gainesville, FL (US)

(21) Appl. No.: 19/045,425

(22) Filed: Feb. 4, 2025

Related U.S. Application Data
(62) Division of application No. 16/764,735, filed on May 15, 2020, now Pat. No. 12,248,123.
(60) Provisional application No. 62/607,987, filed on Dec. 20, 2017.

(51) Int. Cl. G02B 1/118; C03C 17/00; C03C 17/25; G02B 1/12

(52) U.S. Cl. CPC G02B 1/118; C03C 17/004; C03C 17/005; C03C 17/25; G02B 1/12; C03C 2217/213; C03C 2217/732; C03C 2218/111; C03C 2218/115; C03C 2218/32

(57) ABSTRACT

Described herein are antireflective layers, methods for forming antireflective layers, and structures including antireflective layers. Methods are included for forming a durable antireflective layer on the surface of a substrate, wherein the substrate has a complex three-dimensional shape, wherein the durable antireflective layer comprises a uniform monolayer of silica nanoparticles interconnected by SiO₂, a uniform monolayer of silica nanoparticles bonded to the surface of the substrate, or a combination thereof.

### CROSS-REFERENCE TO RELATED APPLICATIONS

This application is the divisional application based on U.S. patent application Ser. No. 16/764,735, filed May 15, 2020, which is the 35 U.S.C. § 371 national stage application of PCT Application No. PCT/US2018/066349, filed Dec. 19, 2018, where the PCT claims priority to, and the benefit of, U.S. provisional application entitled “METHODS OF FORMING AN ANTIREFLECTIVE LAYER ON A COMPLEX SUBSTRATE AND COMPLEX SUBSTRATES HAVING THE ANTIREFLECTIVE LAYER” having Ser. No. 62/607,987, filed Dec. 20, 2017, both of which are herein incorporated by reference in their entireties.

### FEDERAL SPONSORSHIP

This invention was made with government support under HDTRA1-15-1-022 awarded by the Department of Defense/Defense Threat Reduction Agency; and under CMMI1562861 awarded by the National Science Foundation. The government has certain rights in the invention.

### BACKGROUND

Antireflection (AR) coatings that can significantly reduce optical reflection through various optical surfaces are of great technological importance in a wide spectrum of applications ranging from improving light conversion efficiency of solar cells and increasing transmittance of optical lenses to eliminating ghost images for flat-panel displays and reducing glare from automobile dashboards. Traditional quarter-wavelength AR coating employs destructive interference of reflected light from the coating surface and the coating/substrate interface to eliminate unwanted optical reflection and enhance light transmission. Two criteria need to be met to optimize the AR performance of quarter-wavelength coatings: (1) the coating thickness is about one-quarter of the operating wavelength, and (2) the refractive index of the coating is close to the geometric mean of the indices of the substrate and the surrounding media (typically air).

### SUMMARY

Embodiments of the present disclosure provide antireflective layers, structures including antireflective layers, and the like.

An embodiment of the present disclosure includes methods for forming an antireflective layer on a substrate. The method includes disposing a substrate in a solution. The substrate can have a complex three-dimensional shape, wherein one or more surfaces of the substrate are functionalized to have a net positive charge. The solution can include a colloidal suspension of negatively charged silica nanoparticles. The method also includes forming, simultaneously, a uniform monolayer of silica nanoparticles on one or more surfaces of the substrate through electrostatic attraction of the silica nanoparticles and the functionalized surfaces of the substrate to form the antireflective layer on the substrate, removing the substrate from the solution, and treating the antireflective layer with a vapor to form a durable antireflective layer on the substrate. The vapor can include a silicate compound.

An embodiment of the present disclosure also includes structures made from the methods described herein.

An embodiment of the present disclosure also includes structures having a durable antireflective layer on the surface of a substrate. The substrate can have a complex three-dimensional shape. The durable antireflective layer can include a uniform monolayer of silica nanoparticles interconnected by SiO₂, a uniform monolayer of silica nanoparticles bonded to the surface of the substrate, or a combination thereof.

Other compositions, apparatus, methods, features, and advantages will be or become apparent to one with skill in the art upon examination of the following drawings and detailed description. It is intended that all such additional compositions, apparatus, methods, features and advantages be included within this description, be within the scope of the present disclosure, and be protected by the accompanying claims.

### BRIEF DESCRIPTION OF THE DRAWINGS

Further aspects of the present disclosure will be more readily appreciated upon review of the detailed description of its various embodiments, described below, when taken in conjunction with the accompanying drawings.

FIG. 1 is a photograph comparing a glass volumetric flask covered with an example of monolayer silica nanoparticle AR coatings of the present disclosure on both interior and exterior surfaces (left) and a bare flask (right) under white light illumination.

FIGS. 2A-2G provide examples of AR coatings of the present disclosure. FIG. 2A is scheme showing 6 different regions labeled on the exterior and interior surfaces of a volumetric flask. FIGS. 2B-2G are typical SEM images of the regions 1-6 for the coated flask in FIG. 1. FIG. 2H shows average nanoparticle surface coverage ratios for the regions 1-6 on the coated flask.

FIG. 3 shows normal-incidence optical transmission spectra obtained from the pear-shaped bulb part (Region 1/2) and the narrow neck (Region 3/4) of the coated and the bare flasks of FIG. 1.

FIGS. 4A-4B show simulated, color-coded, and stacked optical reflection spectra of an example nanoparticle AR coating consisting of 110 nm particles with different surface coverage ratios presented in (FIG. 4A) 3D and (FIG. 4B) 2D.

The drawings illustrate only example embodiments and are therefore not to be considered limiting of the scope described herein, as other equally effective embodiments are within the scope and spirit of this disclosure. The elements and features shown in the drawings are not necessarily drawn to scale, emphasis instead being placed upon clearly illustrating the principles of the embodiments. Additionally, certain dimensions may be exaggerated to help visually convey certain principles. In the drawings, similar reference numerals between figures designate like or corresponding, but not necessarily the same, elements.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of chemistry, material science, and the like, which are within the skill of the art. Such techniques are explained fully in the literature.

The following examples are put forth so as to provide those of ordinary skill in the art with a complete disclosure and description of how to perform the methods and use the structures disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion

Embodiments of the present disclosure provide for methods of making substrates having an antireflective layer (e.g., durable antireflective layer), substrates having an antireflective layer, devices including a substrate having an antireflective layer, and the like. Embodiments of the present disclosure provide for substrates that have high quality antireflection coatings that are uniform and have excellent antireflection properties and are very durable. In particular, substrates of the present disclosure have light reflection properties and light transmission properties that are superior to currently used antireflective substrates. Embodiments of the present disclosure are advantageous in that the method is simple, inexpensive, and scalable, while providing very durable antireflective layer unlike other competing technologies.

Embodiments of the substrate can have complex two- or three-dimensional geometries. Unlike current technologies, embodiments of the present disclosure can include substrates that have one or more concave, convex, polygonal, or the like inner and outer surfaces. In an aspect, the substrate can have a plurality of concave and convex surfaces. Non-limiting examples of such substrates include complex glassware such as that used in the chemical and biological industries, where the glassware has complex concave and convex surfaces on the inner and outer areas of the glassware. Current techniques are not able to reach the numerous curved surfaces of complex glassware, whereas the wet chemical approach provided herein can reach all inner and outer surfaces of these types of geometrically complex substrates. In an example, the glassware can include: Buchner flask, burette, cold finger, condenser, cuvette, Erlenmeyer flask, Erlenmeyer bulb, Florence flask, Freidrichs condenser, funnel, pipette, retort, round bottom flask, Schlenk flask, separatory funnel, Soxhlet extractor, Thiele tube, volumetric flask, various distillation glassware, vials, graduate cylinder, test tubes, bottles and jars, spot plates, evaporation dishes, boiling flask, suction flask, crystallization dish, long condenser, vacuum adapter, distillation adapter, dropper and the like concave/convex glassware.

Embodiments of the present disclosure provide for an electrostatic-assisted colloidal self-assembly technology for fabricating monolayer nanoparticle antireflective layer (e.g., coating) over large geometrically complex areas of a substrate. This approach can be based on the electrostatic adsorption of negatively charged silica nanoparticles on surface-functionalized glass substrates with positive surface charges. This technology could enable simultaneous coating of both sides (e.g., inner and outer surfaces) of geometrically complex glass substrates. Embodiments of the method are inherently parallel for potential large-scale fabrication of inexpensive antireflective layer with high coating quality and reproducibility.

Embodiments of the present disclosure provide for a simple, inherently parallel, and scalable bottom-up approach for fabricating nanoparticle antireflective layer on geometrically complex substrates. Negatively charged silica nanoparticles can be electrostatically adsorbed onto a surface-functionalized substrate (e.g., glass substrate) with positive surface charges to form a disordered monolayer nanoparticle coating. Specular reflection and transmission measurements demonstrate that good antireflective performance (e.g. about 2 to 3% with two-sided reflection) and high optical transmission (e.g., about 97 to 99%) can be achieved by the self-assembled nanoparticle coatings of the present disclosure. It should be noted that although silica nanoparticles are described above and in some aspects or embodiments, the nanoparticles can include other materials or combinations of materials as provided herein.

In an exemplary embodiment, the method of forming an antireflective layer on a substrate includes forming (e.g., self-assembled), simultaneously, a colloidal monolayer of particles (e.g., silica) on the inner and outer surfaces of a geometrically complex substrate. In an embodiment, the nanoparticles can be attached to the surface of the substrate via electrostatic attraction. In particular, a substrate is disposed in a solution that is exposed to constant mixing (e.g., shaking) during exposure of the substrate to the solution. In an embodiment, shaking the solution continuously during exposure can prevent sedimentation and also ensures constant movement of the nanoparticles in the solution so that they can absorb on the empty surfaces of the substrate. In an embodiment, the shaking can be produced using sonication, mechanical shaking, magnetic stirring, hand shaking, or a combination thereof.

In an embodiment, the substrate can be exposed to the solution for about 10 sec to 120 min, about 30 min to 120 min, about 60 min to 120 min, or about 90 min. In an embodiment, the solution can be exposed to shaking for about 10 sec to 120 min, about 30 min to 120 min, about 60 min to 120 min, or about 90 min.

After exposure to the solution, the coated substrate can be rinsed to remove any unbound nanoparticles to the inner surface and the outer surface. For example, the coated substrate can be exposed to a solvent (e.g., ethanol or another alcohol) and then allowed to air dry.

In an aspect, the substrate including the antireflective layer can be further treated to form a durable antireflective layer. In an embodiment, the durable antireflective layer comprises the uniform monolayer of silica nanoparticles bonded to one another by SiO₂, the uniform monolayer of silica nanoparticles bonded to the substrate surface via SiO₂, or a combination thereof. In an embodiment, the SiO₂ and the silica nanoparticles form a SiO₂-particle network where the silica particles can be attached to one or more other silica particles by SiO₂ and/or the silica particles can be attached to the surface of the substrate by SiO₂. In an aspect, the SiO₂-particle network of the durable antireflective layer does not reduce a transmittance % of the antireflective layer by more than about 4%, about 2%, or about 1%. In an aspect, the SiO₂-particle network does not form a layer of SiO₂ over the surface of the uniform monolayer of silica nanoparticles since forming such a SiO₂ layer would reduce transmittance. In an aspect, the SiO₂-particle network does not form a layer of SiO₂ over the surface of the uniform monolayer of silica nanoparticles that would reduce transmittance by more than about 4%, about 2%, or about 1%.

In an aspect, the SiO₂-particle network can be formed by treating, with a vapor, the antireflective layer on the substrate, where the vapor includes components to form SiO₂. In an embodiment, the components to form the SiO₂ can include a water and a silicate compound in the vapor phase that react on the surface of the antireflective layer. In an aspect, the silicate compound can be selected from: an alkyl group (C2 to C6 alkyl) silane, tetraethoxysilane (TEOS), tetramethyl orthosilicate, 3-isocyanatopropyltriethoxysilane, (3-glycidoxypropyl)methyldiethoxysilane, 3-aminopropyltris(methoxyethoxyethoxy) silane, (3-glycidoxypropyl)bis(trimethylsiloxy)methylsilane, tris(clycidoxypropyldimethylsiloxy)phenylsilane, and a combination thereof. For example, the concentration of the water and silicate compound in the vapor phase can be about 1:1 ratio. In an embodiment, the higher concentration of silicate compound to water will result in shorter treatment time.

In an embodiment, the substrate including the antireflective layer can be positioned in a chamber along with the components to form the SiO₂. For example, the components can separately include water and the silicate compound (e.g., tetraethoxysilane (TEOS)). The substrate and the components can be heated to about a temperature of about 60 to 100° C. for a time frame of about 1 to 3 hours. In an embodiment, the temperature can be about 80° C. and the time frame is about 2.5 hours.

In an embodiment, the light reflected is about 0.5 to 4% over a wavelength of about 400 nm to 800 nm for the substrate having the antireflective layer or the durable antireflective layer. In an embodiment, the light reflected is about 14% for a wavelength of about 550 nm for the substrate having the antireflective layer or the durable antireflective layer. In an embodiment, the light transmission is about 99% or more over a wavelength of about 500 to 650 nm for the substrate having the antireflective layer or the durable antireflective layer. In an embodiment, the substrate has both the light reflected property and the light transmission property.

In an exemplary embodiment, the substrate can include a silicon substrate, a gallium arsenide (GaAs) substrate, a gallium antimonide (GaSb) substrate, indium phosphide (InP), gallium nitride (GaN), sapphire, and the like. In an embodiment, the silicon substrate can include a single crystal silicon substrate, a multi-crystalline substrate, or an amorphous silicon substrate. In an embodiment, the substrate can have a thickness of about 2 μm to 10 cm or more and the length and width can vary depending upon the desired use or application.

In an embodiment, the substrate can have an inner surface and an outer surface that is functionalized to have a net negative charge. In an embodiment, the surface can be functionalized by attaching a functional group that imparts a net positive charge to the surface of the substrate. In an embodiment, the functional group can include an amino group, sulfate group, phosphate group, or a combination thereof. The Examples provide additional details.

In an embodiment, the solution can include nanoparticles. In an embodiment, the nanoparticle can be a silica nanoparticle, polystyrene nanoparticle, titania nanoparticle, alumina nanoparticle, gold nanoparticles, silver nanoparticles, or iron oxide nanoparticles or mixtures thereof. In an embodiment, the nanoparticle can be a silica nanoparticle. In an embodiment, the nanoparticle can have a geometric shape of a sphere or is generally spherical but not 100% spherical. In an embodiment, the nanoparticle can have a diameter of about 50 to 500 nm, about 50 to 300 nm, about 50 to 250 nm, or about 100 to 200 nm. In an embodiment, the mass fraction of nanoparticles present in the solution can be about 1 to 5% or about 1 to 2%, or about 1.6%.

In an embodiment, the solution includes a solvent and water. In an embodiment, the solvent can include methanol, ethanol, isopropanol, acetone, or a combination thereof. In an embodiment, the solvent can be ethanol. In an embodiment, the ratio of solvent to water can be about 80 to 95% by volume of solvent and about 5 to 20% by volume of water, about 85 to 95% by volume solvent and about 5 to 15% by volume of water, or about 90% by volume solvent and about 10% by volume of water. In an embodiment, the silica nanoparticles in the ethanol-water solution can be about 1% to 4% by volume. In a particular embodiment, the ratio of ethanol to water can be about 90% by volume ethanol and about 10% by volume of water and the silica nanoparticles can be about 2.1% by volume in the ethanol-water solution.

In an embodiment, the antireflective layer or the durable antireflective layer has a total specular reflection of about 2% or less, about 1%, or less, or about 0.5% or less, for the entire visible wavelength at an incident angle of about 0° to 90°. The phrase “total specular reflection” means the overall specular reflection obtained from a substrate surface with reflection angle between 0 and 90°. An integration sphere can be used in measuring total specular reflection.

While embodiments of the present disclosure are described in connection with the Example and the corresponding text and figures, there is no intent to limit the disclosure to the embodiments in these descriptions. On the contrary, the intent is to cover all alternatives, modifications, and equivalents included within the spirit and scope of embodiments of the present disclosure.

### Example 1

Vacuum deposition of dielectric films with tightly controlled thicknesses and low refractive indices (e.g., magnesium fluoride with a refractive index of 1.383 at 632.8 nm) is broadly utilized in fabricating quarter-wavelength AR coatings on glass substrates [7,8]. However, traditional vacuum deposition technologies, such as sputtering and plasma-enhanced chemical vapor deposition (PECVD), suffer from high equipment and operating cost, limited selection of coating materials, and low throughput [8]. In addition, it is formidably challenging in coating nonplanar optical surfaces with complex geometries, especially those with enclosed concave surfaces, using the state-of-the-art vacuum deposition approaches [9,10]. For instance, a sophisticated and specially designed magnetron sputtering source with a tuned cylindrical shape has been developed in depositing high-quality quarter-wavelength AR coatings on deep concave optical surfaces [9]. However, this unique equipment design is only optimized for specific geometries. The deposition system and processes need to be redesigned for coating other geometrically complex optical surfaces.

Complementing the complex yet precise vacuum deposition technologies, various solution-based processes have been exploited for fabricating uniform quarter-wavelength AR coatings on a plethora of optical substrates (e.g., glass, plastics, and semiconductors) [11-19]. These wet approaches are generally simpler, faster, less expensive, and more easily applicable to large areas than vacuum-based methodologies [14]. For example, spin coating is a common technique for depositing porous nanoparticle coatings or phase-separated polymer blends with well-controlled thicknesses over planar surfaces [1,3,17]. Layer-by-layer (LBL) deposition of polyelectrolyte and/or nanoparticle multilayers is another popular approach for assembling AR coatings with adjustable thicknesses on both planar and non-planar surfaces [14,20,21]. However, LBL deposition involves multiple electrostatic adsorption and washing steps, which greatly impede the ultimate throughput of the self-assembled AR coatings. This limitation becomes even worse for optical surfaces with complex geometries (e.g., enclosed spaces) as automated LBL deposition processes cannot be easily adapted to improve the yields of the final multilayer coatings [22]. Reported herein is a much simpler and faster electrostatics-assisted self-assembly approach for depositing monolayer nanoparticle AR coatings on geometrically complex surfaces. Importantly, optical measurements and theoretical simulations based on a simplified thin-film multilayer model indicate that optimal nanoparticle surface coverage ratios can be readily achieved by this single-step, solution-based process.

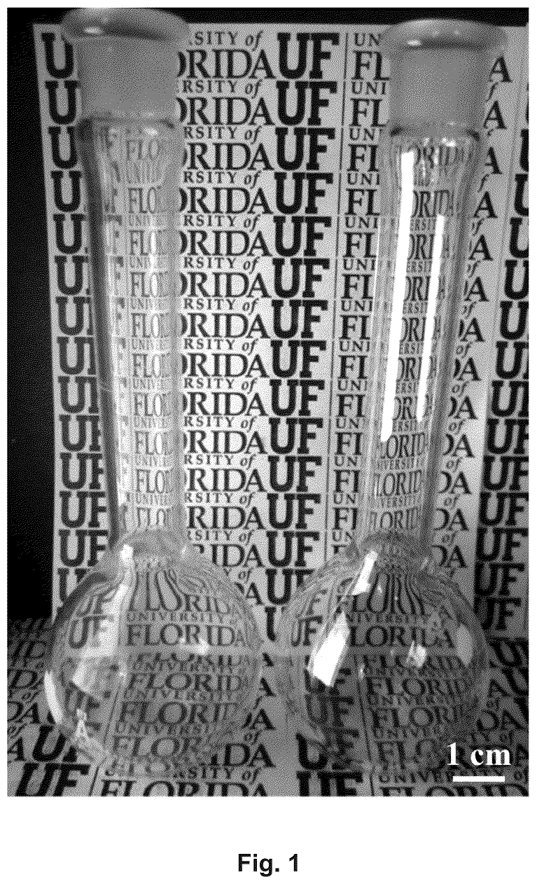

The versatile bottom-up technology described herein is based on electrostatics-assisted adsorption of negatively charged silica nanoparticles on surface-modified optical surfaces possessing positive surface charges. This approach has been extensively employed in assembling monolayer nanoparticle AR coatings on planar substrates [13,15,23-25]. However, the great potential of this simple methodology in fabricating high-quality AR coatings on geometrically complex surfaces has not yet been exploited. The simultaneous deposition of uniform nanoparticle AR coatings is demonstrated on both the interior and exterior surfaces of a 50-mL glass volumetric flask with a long and narrow neck as a proof-of-concept prototype. As shown by the photograph in FIG. 1, the very complex geometry of the flask makes it nearly impossible to deposit dielectric AR coatings on its curved and enclosed surfaces using conventional vacuum-based technologies [9]. To enable electrostatics-assisted adsorption of monolayer nanoparticle AR coatings, the glass volumetric flask is first cleaned using a piranha solution (H₂SO₄:H₂O₂=4:1 by volume) at 70° C. for 30 min. The surface of the glass flask is then modified with 3-aminopropyltriethoxysilane (APS) by immersing in a 2.5 vol. % APS/toluene solution for 2 h through the well-established silane coupling reactions [26]. The amino groups of the covalently bonded APS molecules reverse the glass surface changes from negative to positive. The surface-functionalized volumetric flask is then dipped in a colloidal suspension comprising 4.2 wt. % silica nanoparticles (110 nm diameter and less than 10% diameter standard deviation) dispersed in an ethanol-water mixture with 90 vol. % ethanol for 60 min. The negatively charged silica nanoparticles, which are synthesized by the standard Stöber method and possess a typical zeta potential of ˜−45 mV (measured using a Brookhaven ZetaPlus Analyzer), can be electrostatically adsorbed on the oppositely charged surfaces of the flask. The self-limiting effects caused by the strong electrostatic repulsion between the deposited nanoparticles and the particles in the colloidal suspension lead to the formation of monolayer nanoparticle coatings on the complex flask surfaces. The coated volumetric flask is then rinsed with pure ethanol to remove loosely attached silica nanoparticles and is finally air-dried.

FIG. 1 shows a photograph that compares a coated volumetric flask with the electrostatically adsorbed monolayer nanoparticle AR coatings (left) with a bare flask (right) under white light illumination. The coated flask exhibits characteristic purplish/bluish hue and significantly reduced light reflection than the uncoated flask. Importantly, the attached silica nanoparticles evenly cover the whole body of the flask (both interior and exterior), indicating high uniformity of the self-assembled nanoparticle AR coatings. The reproducibility of this simple colloidal self-assembly technology was further evaluated by consecutively coating 3 volumetric flasks using the same colloidal suspension. The final AR coatings are nearly identical in their visual appearance and antireflection performance. In addition to enable monolayer nanoparticle deposition, the strong electrostatic attraction between the oppositely charged glass surfaces and the silica nanoparticles can also stabilize the adsorbed nanoparticle coatings. Further improvement in the mechanical strength/durability of the self-assembled AR coatings can be achieved by thermally annealing the coated flasks at 450° C. for 1 h.

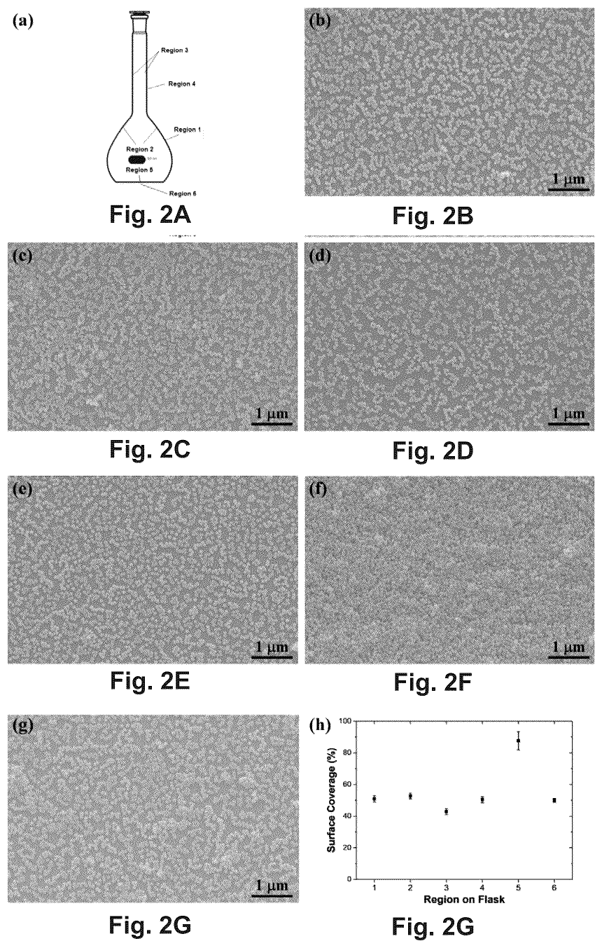

Scanning electron microscope (SEM) is used in characterizing the microstructures of the electrostatically adsorbed nanoparticle AR coatings on various regions of the coated volumetric flask. As shown by the schematic illustration in FIG. 2A, 6 different regions on the exterior and interior surfaces of the flask are arbitrarily assigned and labeled. The typical top-view SEM images in FIGS. 2B and 2C illustrate the spatial distribution of the adsorbed silica nanoparticles on the interior (Region 1) and exterior (Region 2) surfaces of the pear-shaped bulb part of the coated volumetric flask shown in FIG. 1. It is apparent that the assembled silica nanoparticles are randomly arranged and they form monolayer colloidal clusters. The average nanoparticle surface coverage ratios of these regions are determined to be 51.0±2.0% and 52.8±1.9% by analyzing multiple SEM images using an ImageJ program. FIGS. 2D and 2E show the nanoparticle distribution on the interior (Region 3) and exterior (Region 4) surfaces of the long neck of the flask. The nanoparticle surface coverage ratio of the Region 3 (42.9±1.9%) is slightly lower than that of the Region 4 (50.4±1.8%). The gravitational sedimentation of silica nanoparticles (with a density of ˜2.0 g/cm³) in the narrow neck region could lead to this relatively lower surface coverage ratio. Another apparent effect of the gravitational sedimentation is the formation of a dense, multilayer nanoparticle coating with a very large surface coverage ratio (87.6±5.8%) on the inner surface of the flat bottom of the flask (Region 5) as shown by the SEM image in FIG. 2F. By contrast, FIG. 2G reveals that patchy colloidal monolayers with an average surface coverage ratio of 49.9±1.2% cover the exterior flat bottom of the flask (Region 6). FIG. 2H compares the average nanoparticle surface coverage ratios for all 6 regions on the coated volumetric flask. Except for the interior bottom surface, where the randomly deposited nanoparticles make a multilayer coating with a very large coverage ratio, the electrostatically assembled nanoparticles on all other regions exhibit average surface coverage ratios close to 50%.

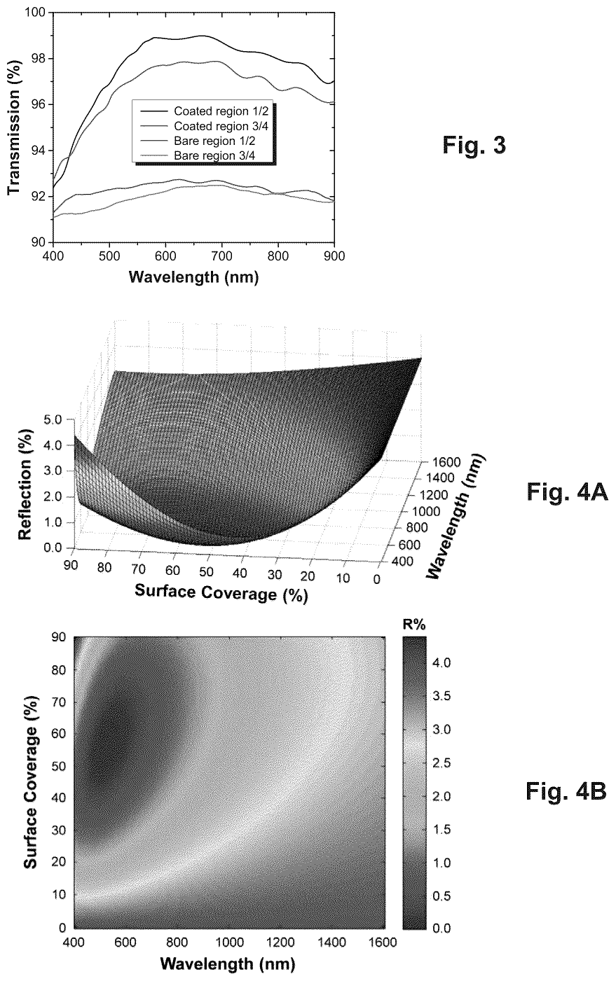

The antireflection performance of the self-assembled nanoparticle AR coatings on different regions of the flask is evaluated through optical transmission measurements using an Ocean Optics HR400 high-resolution vis-NIR spectrometer with a calibrated halogen light source. The nanoparticle-coated and the bare volumetric flasks are carefully broken into small pieces prior to optical tests. Transmission measurements for different regions of the flasks are then performed at normal incidence and the beam spot size is ˜0.8 mm on the sample surface. Combined with the small cone angle of collection (<5°) enabled by the optical fiber probe of the spectrometer, this miniature spot size can effectively reduce the unwanted optical distortion caused by the nonplanar surfaces of the flasks with different curvatures. FIG. 3 compares the optical transmission spectra obtained from the bulb and the neck parts of the nanoparticle-coated and the bare volumetric flasks shown in FIG. 1. The untreated glass regions exhibit a lower transmittance of ˜91-92% for wavelengths between 400 and 900 nm, indicating a single-sided reflectance of ˜4.0-4.5% from a bare glass/air interface. This value favorably agrees with the predication using the Fresnel equation [7]:

$$R = {( \frac{{n}_{1} - {n}_{2}}{{n}_{1} + {n}_{2}} )}^{2} \qquad ( 1 )$$

where R is the optical reflectance at normal incidence, n₁ and n₂ are refractive indices of glass (˜1.5 for common glass) and air (1.0). The good AR performance of the electrostatically assembled silica nanoparticle coatings is confirmed by the significantly improved light transmission through the coated regions. The bulb part shows >97% transmittance for wavelengths from 500 to 900 nm; while the neck region exhibits a slightly lower transmittance of >96% for the same wavelength range. Importantly, for a narrow band of wavelengths (e.g., ˜550-˜700 nm), high transmittance (near 99% for the bulb part and 98% for the neck region) can be achieved. The lower transmittance through the coated neck region than the coated bulb part is possibly affected by the larger curvature of the corresponding glass surface. In addition, the lower nanoparticle surface coverage ratios exhibited by the neck regions, especially on the inner glass surface (see FIGS. 2D and 2H), can also affect the final AR performance.

To gain fundamental insights into the effects of the nanoparticle surface coverage ratio on the optical performance of self-assembled nanoparticle AR coatings, as well as pursue rational design and fabrication of optimal coatings, numerical simulations were performed using a simplified thin-film multilayer model [27]. In this method, the silica nanoparticle monolayers are first divided into 100 horizontal circular layers. The radius of each layer (r*) can be correlated with the z-coordinate (z*) as:

$${r}^{*} = \sqrt{{r}^{2} - {( {z}^{2} - r )}^{2}} \qquad ( 2 )$$

where r is the radius of silica nanoparticles and 0≤z*≤2r. The fraction of silica (with n_{silica}=1.5) in the horizontal layer at height z* can be calculated as:

$$f ( {z}^{*} ) = \frac{{( {r}^{*} )}^{2}}{{r}^{2}} {f}_{sa} \qquad ( 3 )$$

where fₛₐ is the nanoparticle coverage ratio. The effective refractive index of the layer at level z* can be approximated as:

$$n ( {z}^{*} ) = {[ f ( {z}^{*} ) {n}_{silica}^{q} + ( 1 - f ( {z}^{*} ) ) {n}_{air}^{q} ]}^{\frac{1}{q}} \qquad ( 4 )$$

where q=2/3 based on the effective medium theory [27]. Once^{n(z*)} is determined, the normal-incidence reflection of the system is calculated by solving the Maxwell equation to get the electromagnetic fields in each layer [27]. The electromagnetic boundary conditions between neighboring layers are finally applied in sequence to generate the reflected field amplitudes.

The optical modeling results for a randomly arranged nanoparticle AR coating comprising 110 nm silica particles with different surface coverage ratios are shown by the color-coded and stacked optical reflection spectra in both 3D (FIG. 4A) and 2D (FIG. 4B). It is apparent that the nanoparticle surface coverage ratio plays a critical role in determining the antireflection performance of the self-assembled nanoparticle AR coatings. The minimal optical reflection occurs when nanoparticles cover only ˜50-60% of a glass surface, which favorably coincides with the typical nanoparticle surface coverage ratios achieved by the current electrostatics-assisted colloidal self-assembly technology (see FIG. 2H). In addition, the wavelength range showing the highest light transmittance (see FIG. 3) match reasonably well with optical simulation results (i.e., the regions with the darkest colors in FIG. 4B). Moreover, the numerical modeling indicates that the minimal reflection wavelength slightly red-shifts with increasing nanoparticle surface coverage ratio. This can be explained by using the traditional quarter-wavelength condition [18]:

$${λ}_{0} = 4 {n}_{c} {h}_{c} \qquad ( 5 )$$

where λ_{D} is the minimal reflection wavelength, n_{c} and h_{c} are the effective refractive index of the nanoparticle coating and the coating thickness (equals the nanoparticle diameter), respectively. An increase in the nanoparticle surface coverage ratio leads to a higher n_{c} and thus the red shift of the minimal reflection wavelength.

In conclusion, a simple yet versatile bottom-up technology is described based on electrostatics-assisted colloidal self-assembly for fabricating nanoparticle AR coatings on geometrically complex optical surfaces, which are formidably challenging or even completely impossible to be coated by conventional top-down and bottom-up approaches. The electrostatically adsorbed monolayer silica nanoparticles cover ˜50% of the substrate surface, which is predicted to be within the optimal surface coverage range for achieving minimal light reflection by the optical modeling.

### REFERENCES

1. S. Walheim, E. Schäffer, and U. Steiner, Science 283, 520 (1999).
2. J. A. Hiller, J. D. Mendelsohn, and M. F. Rubner, Nat. Mater. 1, 59 (2002).
3. M. Ibn-Elhaj and M. Schadt, Nature 410, 796 (2001).
4. C. L. Fang, J. Zheng, Y. J. Zhang, Y. J. Li, S. Y. Liu, W. J. Wang, T. Jiang, X. S. Zhao, and Z. H. Li, ACS Appl. Mater. Interfaces 10, 21950 (2018).
5. Y. Li, D. B. Fullager, E. Angelbello, D. Childers, G. Boreman, and T. Hofmann, Opt. Lett. 43, 239 (2018).
6. L. Yao, Z. Qu, Z. L. Pang, J. Li, S. Y. Tang, J. H. He, and L. L. Feng, Small 14, 1801661 (2018).
7. H. A. Macleod, Thin-Film Optical Filters, Third ed. (Institute of Physics Publishing, Bristol, 2001).
8. G. P. Du, Y. Zhang, W. Li, N. Chen, B. F. Liu, and J. Sun, Prog. Photovol. 23, 1806 (2015).
9. T. D. Rhmlow, J. E. Lazo-Wasem, M. B. Moran, and L. F. Johnson, Proc. SPIE 7660, 766026 (2010).
10. K. Pfeiffer, U. Schulz, A. Tunnermann, and A. Szeghalmi, Coatings 7, 118 (2017).
11. C. Y. Lin, K. Y. A. Lin, T. W. Yang, Y. C. Chen, and H. T. Yang, J. Colloid Interface Sci. 490, 174 (2017).
12. P. Buskens, M. Burghoorn, M. C. D. Mourad, and Z. Vroon, Langmuir 32, 6781 (2016).
13. X. Li, O. Niitsoo, and A. Couzis, J. Colloid Interface Sci. 394, 26 (2013).
14. H. Shimomura, Z. Gemici, R. E. Cohen, and M. F. Rubner, ACS Appl. Mater. Interfaces 2, 813 (2010).
15. B. T. Liu and W. D. Yeh, Thin Solid Films 518, 6015 (2010).
16. B. G. Prevo, E. W. Hon, and O. D. Velev, J. Mater. Chem. 17, 791 (2007).
17. Y. Zhao, J. S. Wang, and G. Z. Mao, Opt. Lett. 30, 1885 (2005).
18. K. Askar, B. M. Phillips, X. Dou, J. Lopez, C. Smith, B. Jiang, and P. Jiang, Opt. Lett. 37, 4380 (2012).
19. K. Askar, B. M. Phillips, Y. Fang, B. Choi, N. Gozubenli, P. Jiang, and B. Jiang, Colloid Surf. A 439, 84 (2013).
20. W. S. Tan, Y. Du, L. E. Luna, Y. Khitass, R. E. Cohen, and M. F. Rubner, Langmuir 28, 13496 (2012).
21. Y. Du, L. E. Luna, W. S. Tan, M. F. Rubner, and R. E. Cohen, ACS Nano 4, 4308 (2010).
22. G. M. Nogueira, D. Banerjee, R. E. Cohen, and M. F. Rubner, Langmuir 27, 7860 (2011).
23. X. T. Zhang, O. Sato, M. Taguchi, Y. Einaga, T. Murakami, and A. Fujishima, Chem. Mater. 17, 696 (2005).
24. B. T. Liu and W. D. Yeh, Colloids Surf. A 356, 145 (2010).
25. K. Askar, J. M. Wang, S. Y. Leo, C. Kim, A. M. Fenton, P. Jiang, and B. Jiang, Thin Solid Films 621, 156 (2017).
26. E. Metwalli, D. Haines, O. Becker, S. Conzone, and C. G. Pantano, J. Colloid Interface Sci. 298, 825 (2006).
27. D. G. Stavenga, S. Foletti, G. Palasantzas, and K. Arikawa, Proc. R. Soc. B 273, 661 (2006).

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to significant figures of the numerical value. In addition, the phrase “about ‘x’ to ‘y’” includes “about ‘x’ to about ‘y’”.

While only a few embodiments of the present disclosure have been shown and described herein, it will become apparent to those skilled in the art that various modifications and changes can be made in the present disclosure without departing from the spirit and scope of the present disclosure. All such modification and changes coming within the scope of the appended claims are intended to be carried out thereby.

We claim at least the following:

1. A method of forming a structure having an antireflective layer on a substrate, comprising:
disposing a substrate in a solution, wherein the substrate has a complex three-dimensional shape, wherein one or more surfaces of the substrate are functionalized to have a net positive charge, wherein the solution includes a colloidal suspension of negatively charged silica nanoparticles;
forming, simultaneously, a uniform monolayer of silica nanoparticles on the one or more surfaces of the substrate through electrostatic attraction of the silica nanoparticles and the functionalized surfaces of the substrate to form the antireflective layer on the substrate;
removing the substrate from the solution; and
treating, with a vapor, the antireflective layer on the substrate to form a durable antireflective layer on the substrate, wherein the vapor includes a silicate compound.

2. The method of claim 1, wherein the silicate compound is selected from the group consisting of: an alkyl group silane, tetraethoxysilane (TEOS), tetramethyl orthosilicate, and a combination thereof.

3. The method of claim 2, wherein treating includes heating the substrate to about a temperature of about 60 to 100° C. for a time frame of about 1 to 3 hours, wherein the ratio of water to silicate is about 1:1.

4. The method of claim 3, wherein the temperature is about 80° C. and wherein the time frame is about 2.5 hours.

5. The method of claim 1, wherein the durable antireflective layer comprises the uniform monolayer, wherein the silica nanoparticles are bonded to one another, wherein the uniform monolayer of silica nanoparticles are bonded to the substrate surface via SiO₂-particle network, or a combination thereof, optionally wherein the SiO₂-particle network of the durable antireflective layer does not reduce a transmittance % of the antireflective layer by more than 2%.

6. The method of claim 5, wherein the SiO₂-particle network does not form a layer of SiO₂ over the surface of the uniform monolayer of silica nanoparticles.

7. The method of claim 1, wherein the solution including negatively charged silica nanoparticles is a colloidal suspension including about 90% by volume ethanol, about 10% by volume of water, and a volume fraction of about 1% to 4% of silica nanoparticles, optionally wherein the colloidal suspension includes a mass fraction of about 1% to 4% of silica nanoparticles dispersed in the solution.

8. The method of claim 7, wherein the solution includes a mass fraction of about 1.6% of silica nanoparticles.

9. The method of claim 26, wherein the silica nanoparticles have a diameter of about 100 to 200 nm.

10. The method of claim 1, wherein exposing is conducted for about 90 minutes.

11. The method of claim 1, wherein the substrate is selected from the group consisting of: a silicon substrate, a gallium arsenide (GaAs) substrate, a gallium antimonide (GaSb) substrate, indium phosphide (InP), and gallium nitride (GaN).

12. The method of claim 1, wherein the complex three-dimensional shape has one or more of a concave inner surface, a concave outer surface, a convex inner surface, a convex outer surface, a polygonal inner surface, and a polygonal outer surface.

13. The method of claim 1, wherein the structure is selected from a Buchner flask, a burette, a cold finger, a condenser, a cuvette, an Erlenmeyer flask, an Erlenmeyer bulb, a Florence flask, a Freidrichs condenser, a funnel, a pipette, a retort, a round bottom flask, a Schlenk flask, a separatory funnel, a Soxhlet extractor, a Thiele tube, a volumetric flask, a distillation glassware, a vial, a graduated cylinder, a test tube, a bottle, a jar, a spot plate, an evaporation dish, a boiling flask, a suction flask, a crystallization dish, a long condenser, a vacuum adapter, a distillation adapter, and a dropper.

14. A method of forming a structure having an antireflective layer on a substrate, comprising:
disposing a substrate in a solution, wherein the substrate has a complex three-dimensional shape having an inner surface and an outer surface, wherein the inner surfaces comprises one or more of a concave inner surface, a convex inner surface, and a polygonal inner surface, wherein the outer surface comprises one or more of a concave outer surface, a convex outer surface, and a polygonal outer surface, wherein the inner surfaces and the outer surfaces of the substrate are functionalized to have a net positive charge, wherein the solution includes a colloidal suspension of negatively charged silica nanoparticles;
forming, simultaneously, a uniform monolayer of silica nanoparticles on the one or more inner and outer surfaces of the substrate through electrostatic attraction of the silica nanoparticles and the functionalized surfaces of the substrate to form the antireflective layer on the substrate;
removing the substrate from the solution; and
treating, with a vapor, the antireflective layer on the substrate to form a durable antireflective layer on the substrate, wherein the vapor includes a silicate compound,
the durable antireflective layer comprises a uniform monolayer of silica nanoparticles attached to one or more other silica nanoparticles by SiO₂, wherein the uniform monolayer of silica nanoparticles is bonded directly to the inner surface of the substrate surface via a covalent SiO₂-particle network, wherein the uniform monolayer of silica nanoparticles is bonded directly to the outer surface of the substrate surface via a covalent SiO₂-particle network, wherein the silica nanoparticles have a diameter of about 100 to 200 nm.

15. The structure of claim 14, wherein the substrate is selected from the group consisting of: a silicon substrate, a gallium arsenide (GaAs) substrate, a gallium antimonide (GaSb) substrate, indium phosphide (InP), and gallium nitride (GaN).

16. The structure of claim 15, wherein the substrate is a silicon substrate.
